(19) United States
(12) Patent Application Publication
(10) Pub. No.: US 2002/0178434 A1
(43) Pub. Date: Nov. 28, 2002

(54) Apparatus and method for automatic source code generation in a process control environment

(76) Inventors: Gary L. Fox, Phoenix, AZ (US); Kenneth W. Dietrich, Glendale, AZ (US); Donald M. James, Phoenix, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 09/791,010

(22) Filed: Feb. 22, 2001

(51) Int. Cl. G06F 9/44

(52) U.S. Cl. 717/106

(57) ABSTRACT

There is disclosed an apparatus for automatically creating an original source code segment to insert into system program source code. The apparatus comprises: (1) a database coupled to at least one external data source and the database is capable of receiving external data source parameters as input data, (2) an interactive help application that is capable of utilizing parameters from the database to form program source code variables, and (3) a source code generator that is coupled to both the database and the interactive help application, wherein the source code generator is capable of automatically generating a final version of the source code portion and inserting the new code in the appropriate location in the program source code.

### TECHNICAL FIELD OF THE INVENTION

The present invention is directed, in general, to control systems for plant processing facilities and, more specifically, to an apparatus and method for automatic code generation for operating process control systems.

### BACKGROUND OF THE INVENTION

Presently, processing facilities, including manufacturing plants, chemical plants, crude oil refineries and ore processing plants, are typically managed using distributed process control systems. Contemporary control systems include numerous modules tailored to control or monitor various associated processes of the facility. Conventional means link these modules together to produce the distributed nature of the control system. This affords increased performance and a capability to expand or reduce the control system to satisfy changing facility needs.

In prior art systems the distributed control solution to a complex process incorporating various hardware components (e.g., sensors and actuators) involved hand generating reams of software code specially adapted to the computing platform and the exact specification of the physical process. Even relatively simple, and similar, distributed control solutions were invariably built from the ground up, and, therefore, every alteration of hardware in the process required laborious, time-consuming evaluation of the impact of each such change on the control solution. Typically, weeks or even months of effort are needed to configure a plant-wide process control system. Days or even weeks may be needed to make changes to the control system following a change of device components, which may require a stoppage of the process and a reevaluation of the impact of the change on remote portions of the controlled process. Also, program source code, constructed by prior art methods, inevitably loses the structure and interrelationships after the software code is compiled. Lengthy efforts are then required to recreate the originally defined data structure and interrelationships.

Traditionally, control engineers were required to investigate the details of process code (that have little to do with process control theory or practical solutions) to make algorithms required to monitor and implement process actions that execute correctly within a control system. This has been due to the fact that general purpose operating systems do not provide a useful set of high-level design abstractions for the control domain, e.g., the ability to easily detect specific control-related events or schedule tasks appropriately for more advanced, multi-variable controls.

Process facility management providers, such as Honeywell Inc., develop control systems that can be tailored to satisfy wide ranges of process requirements (e.g., global, local, etc.) and facility types (e.g., manufacturing, refining, etc.). A primary objective of such providers is to centralize control of as many processes as possible to improve the overall efficiency of the facility. Each process, or group of processes, has associated with it certain input characteristics (e.g., flow, feed, power, etc.) and certain output characteristics (e.g., temperature, pressure, etc.). Each process requires programming code that will provide at least some control over a particular device. The code is usually written to control or receive data from a particular manufacturer's device. If the device is changed out or a different device is substituted to control or monitor a process, then the control and applications engineers on site must write, or generate, code for the device. As described above, this is a lengthy and time consuming process that impacts the productivity of the control engineers involved and the process control system itself.

Therefore, it would be desirable to have an easy and efficient system and method for generating source code for applications that access process data. Further, it would be desirable to add and remove data, characteristics, and control code for devices that are added to or removed from the control system.

### SUMMARY OF THE INVENTION

To address the above-discussed deficiencies of the prior art, it is a primary object of the present invention to provide an easy and efficient way to create and maintain applications that access process data in a process control system. A source code application that controls, or manages, process control systems is maintained and modified utilizing an apparatus comprising software tools. In an advantageous embodiment of the present invention, an apparatus is disclosed that automatically creates an original source code portion to insert into system program source code. The apparatus comprises: (1) a database coupled to at least one external data source and capable of receiving external data source parameters as input data, (2) an interactive help application capable of utilizing parameters from the database to form program source code variables, and (3) a source code generator that is coupled to both the database and the interactive help application, wherein the source code generator is capable of automatically generating a final version of the source code portion and inserting the new code in the appropriate location in the program source code.

In one embodiment of the present invention at least one process controller is provided in a process control system that is coupled to the program source code. The process controller is capable of implementing the newly created source code portion in the process control system.

In another embodiment of the present invention an intermediate source code application is provided that is capable of updating at least a first version of the source code portion.

In yet another embodiment of the present invention a template source code application is coupled to the source code generator to be utilized by the interactive help application to initiate the creation of the source code portion.

In a further embodiment of the present invention an external data source that is connected to the process control system is capable of transmitting parameters of the external data source to the database when queried by the process control system.

In still another embodiment of the present invention the external data source input data is manually entered into the database.

In another embodiment of the present invention, a user can manually delete external data source input data to said database and modify a definition of the external data source stored in said database, utilizing the source code generator.

Those skilled in the art will understand that controllers may be implemented in hardware, software, or firmware, or some suitable combination of the same and, in general, that the use of computing systems in control systems for process facilities is known. The phrase “associated with” and derivatives thereof, as used herein, may mean to include, be included within, interconnect with, contain, be contained within, connect to or with, couple to or with, be communicable with, cooperate with, interleave, be a property of, be bound to or with, have, have a property of, or the like; the term “include” and derivatives thereof, as used herein, are defined broadly, meaning inclusion without limitation; and the term “or,” as used herein, means and/or.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a block diagram of an exemplary process facility in which a control system utilizing the present invention may be implemented;

FIG. 2 illustrates a high-level block diagram of source code generator control software components according to an advantageous embodiment of the present invention; and

FIG. 3 illustrates a method for automatically generating source code in a process control environment according to an advantageous embodiment of the present invention.

### DETAILED DESCRIPTION OF THE INVENTION

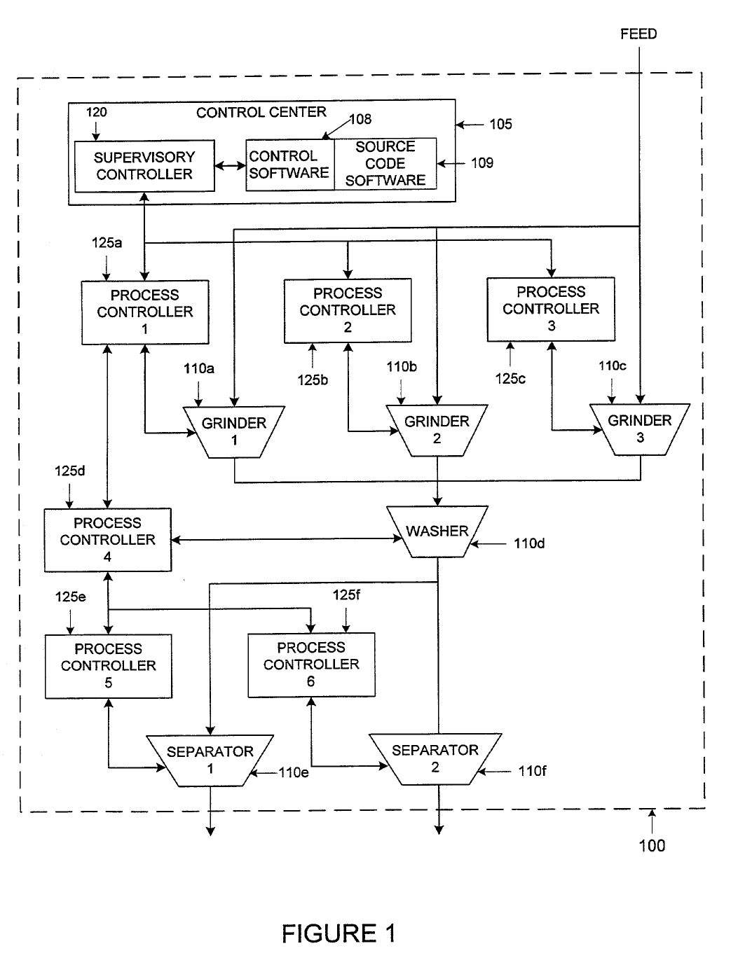

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged process control environment.

FIG. 1 illustrates a block diagram of an exemplary process facility 100 in which a control system according to the principles of the present invention may be implemented. Exemplary process facility 100 processes raw materials and includes an exemplary control center 105 and six associated processes, items 110a-110f, arranged in three stages. The term “include,” as used herein, means inclusion without limitation. Exemplary control center 105 may comprise a central area that is commonly manned by an operator (not shown) for monitoring and controlling the three exemplary process stages. A first process stage includes three raw material grinders 110a-110c that receive a feed of raw material and grind the same, such as by using a pulverizer or a grinding wheel, into smaller particles of raw material. The second process stage includes a washer 110d that receives and cleans the ground raw materials to remove residue from the first stage. The third process stage includes a pair of separators 110e and 110f that separates the ground, washed raw materials into desired minerals and any remaining raw materials. Since this process facility is provided for purposes of illustration only and the principles of such a facility are well known, further discussion of the same is beyond the scope of this patent document and unnecessary.

The exemplary control system includes control software 108 and source code generator control software 109 for a supervisory controller 120 and six process nodes, or process controllers 125a-125f, each of which is implemented in software and executable by a suitable conventional computing system (standalone or network), such as any of Honeywell Inc.'s AM K2LCN, AM K4LCN, AM HMPU, AxM or like systems. Those skilled in the art will understand that such controllers may be implemented in hardware, software, or firmware, or some suitable combination. In general, the use of computing systems in control systems for process facilities is well known.

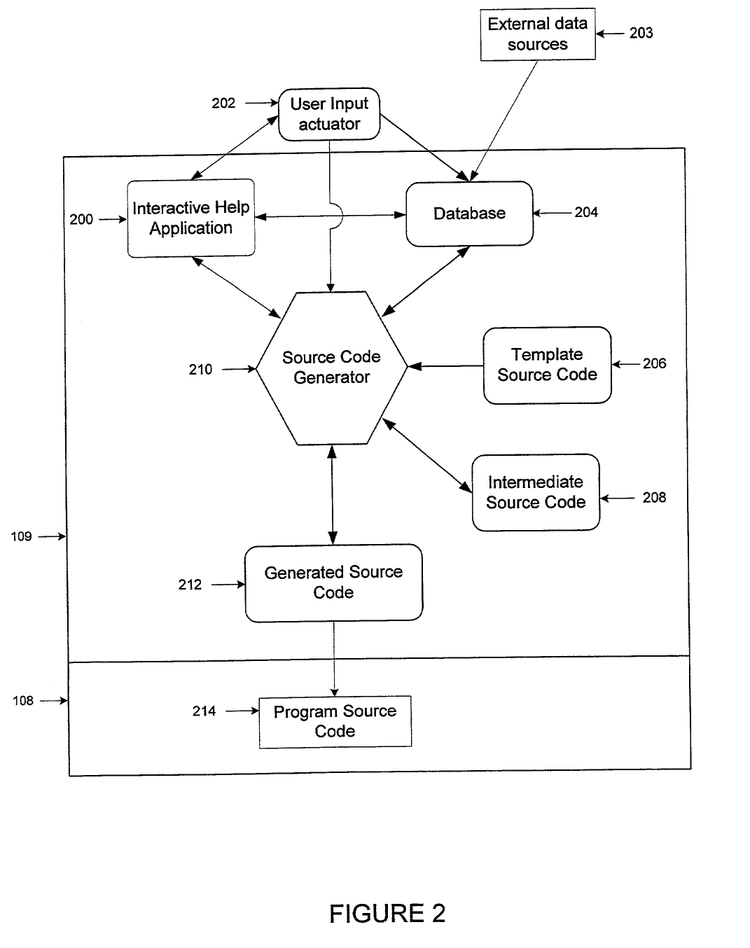

Control software 108 is a modifiable module included in software incorporated in supervisory controller 120. Software utilized by supervisory controller 120 may include an environment such as Honeywell Inc.'s PlantScape product. Source code generator control software 109 includes an automatic code generation product, source code generator 210, that uses a common database and a standard programming development environment to describe external data. The description and organization of source code generator control software 109 is set forth in FIG. 2.

Supervisory controller 120 is associated with each of process controllers 125, directly or indirectly, to allow the exchange of information. The phrase “associated with” and derivatives thereof, as used herein, may mean to include within, interconnect with, contain, be contained within, connect to or with, couple to or with, be communicable with, cooperate with, interleave, be a property of, be bound to or with, have, have a property of, or the like. Supervisory controller 120 monitors characteristics (e.g., status, temperature, pressure, flow rate, current, voltage, power, utilization, efficiency, cost and other economic factors, etc.) of associated processes 110, either directly or indirectly through process controllers 125 associated with processes 110. Depending upon the specific implementation, such monitoring may be of an individual process, a group of processes, or the whole facility.

Supervisory controller 120 communicates with associated processes 110 via process controllers 125 and generates supervisory data in order to optimize the operation of process facility 100. The phrase “supervisory data,” as used herein, is defined as any numeric, qualitative or other value generated by supervisory controller 120 to control (e.g., direct, manage, modify, recommend to, regulate, suggest to, supervise, cooperate, etc.), for example, a particular process, a group of processes, the whole facility, a process stage, a group of stages, a sequence of processes or stages, in essence to optimize the facility as a whole. In a preferred embodiment, the supervisory data is dynamically generated and is based upon at least one of a given facility's efficiency, production, or economic cost and most preferably all three.

Process controllers 125 monitor associated processes 110 and operate to varying degrees in accordance with the supervisory data to control the associated processes 110 and, more particularly, to modify one or more processes and improve the monitored characteristics and the facility as a whole. The relationship between supervisory controller 120 and various ones of process controllers 125 may be master-slave (full compliance), cooperative (varying compliance, such as by using the supervisory data as a factor in controlling the associated processes), or complete disregard (noncompliance). Depending upon the specific implementation and the needs of a given facility, the relationship between supervisory controller 120 and a specific process controller 125 may be static (i.e., always only one of compliance, cooperative, or noncompliance), dynamic (i.e., varying over time, such as within a range between compliance and noncompliance, or some lesser range in between), or switching between static periods and dynamic periods.

FIG. 1 depicts the process controllers 125a-f as simple logic blocks coupled to the processes 110a-f for purposes of illustration only. In reality, the process controllers 125a-f may be implemented in process facility 100 as any of a wide range of devices. In the simplest embodiments, an exemplary process controller 125 may be a micro-controller circuit fabricated on a circuit board and integrated into one of the processes 110 (i.e., part of a separator, washer, or grinder that is being controlled). In other embodiments, an exemplary process controller 125 may be a stand-alone computer, such as a personal computer (PC), that is remote from the controlled process 110 and coupled to it by a BUS architecture.

In more complex embodiments, an exemplary process controller 125 may be a network node coupled to one or more processes 110 by a network architecture. The supervisory controller 120 may then treat the network containing the exemplary process controller 125 and its associated processes 110 as a single functional group. Finally, an exemplary process controller 125 may be a group of process controllers and their associated processes 110 that are networked together. The networked group may then be treated as a single functional group by supervisory controller 120.

The process controllers 125a-f produce process data that is used by the supervisory controller 120 for a variety of purposes, including generating the supervisory data and distributing the process data to one or more client applications. Process data may also be used by the process controller 125 that produced it to control the associated process 110. For example, a process controller 125 may read physical parameter data from a process 110, such as temperature, pressure, flow rate, and the like, and use some or all of that process data and, perhaps, some supervisory data to control the process 110. This is particularly true in a feedback-controlled process.

Process data may be transferred directly between process controllers 125a-f in a peer-to-peer relationship, as in a LAN network. For example, process controller 4 (item 125d), which controls the washer (item 110d), may request process data from process controllers 1-3, which control grinders 1-3, in order to determine the rate at which ground raw material is being output from grinders 1-3. The washer may thereby adjust the rate at which it washes the ground material. For example, the washer may reduce the amount of power that it uses to wash the ground raw material when the amount of ground raw material being sent to the washer is relatively low. It may even temporarily shut down in order to “hold and wait” for a suitable amount of ground raw material to accumulate before it resumes washing.

In some embodiments of the present invention, the supervisory controller 120 may comprise a LAN, a group of connected LANs, or a WAN architecture. One or more client applications are executed on nodes of the LAN/WAN architecture. The nodes may be, for example, personal computers (PCs). The client applications may all require the same process data and supervisory data to be transferred at the same update rate from the process controllers. However, a more likely scenario is that the client applications require different, possibly over-lapping, subsets of the process data and supervisory data and require the process data and supervisory data to be transferred at different update rates to different client applications.

FIG. 2 illustrates a high-level block diagram showing the organization of source code generator control software 109 in accordance with an advantageous embodiment of the present invention. Source code generator control software 109 in the present invention includes interactive help application 200. Interactive help application 200 acts as an interface to guide a user through each step of adding to or changing the source code and database. Included in interactive help application 200 is an in-process dynamic link library (DLL) add-in that seamlessly integrates a development environment for generating Fortran Step and Sequence executables. This in-process DLL provides the user the ability to accomplish all of the code generation functions through graphic buttons added through a Microsoft Developer Studio user interface. Interactive help utility 200 interconnects with user input actuator 202, database 204 and source code generator 210 in order to generate source code for additions or changes to the source code of a process control system. User input actuator 202 is the entry module by which the engineer (1) identifies the external data sources 203 (process monitors, controllers, sensors, etc.) that should be accessed; (2) provides program variables for external data sources 203 to use when program variables are not automatically provided by external data sources 203 themselves; (3) provides the location in which source code generator 210 has to insert Reads and Writes in the operating source code; and (4) provides the error checks to perform.

Database 204 contains definitions of lists of each external data source 203 variables that are to be received by source code generator 210. Data contained in database 204 may be manually entered by a user or may be automatically entered. A process control management system may query embedded software in a newly installed device. Many process control devices are able to provide parameters, when queried, that are associated with the device. As the device is installed in a control system, the process control management application may signal the device and, in response to the signal, the software imbedded in the device provides parameters to the process control management application. Database 204 may be an Excel™ workbook. Excel™ is a trademark of Microsoft Corporation of Redmond, Wash. The workbook is automatically added to a project when the wizard portion of interactive help application 200 creates the project. The workbook may be divided into two areas consisting of both user defined data and system defined data. System defined data is contained in hidden worksheets (not shown) that contain information automatically generated by source code generator 210 and not modified by the user. The format of database 204 is based on a custom template provided by template source code 206.

Template source code 206 contains special markers that allow source code generator 210 to identify the various entries in database 204 and the location in generated source code 212 to place the markers. Intermediate source code 208 is the working (preliminary) version of generated source code 212 as source code generator 210 adds and deletes code related to external data sources 203 from user input actuator 202. Generated source code 212 is the final output from source code generator 210. Generated source code 212 contains all of the generated source code as specified by the entries from user input actuator 202. The user may add additional source code to generated source code 212 to implement a specific application behavior. Source code generator 210 can be re-entered later to modify external data outputs or to add or remove Reads and Writes to generated source code 212.

A final source code version is then passed from generated source code 212 and is automatically inserted into a selected program source file 214 within control software 108.

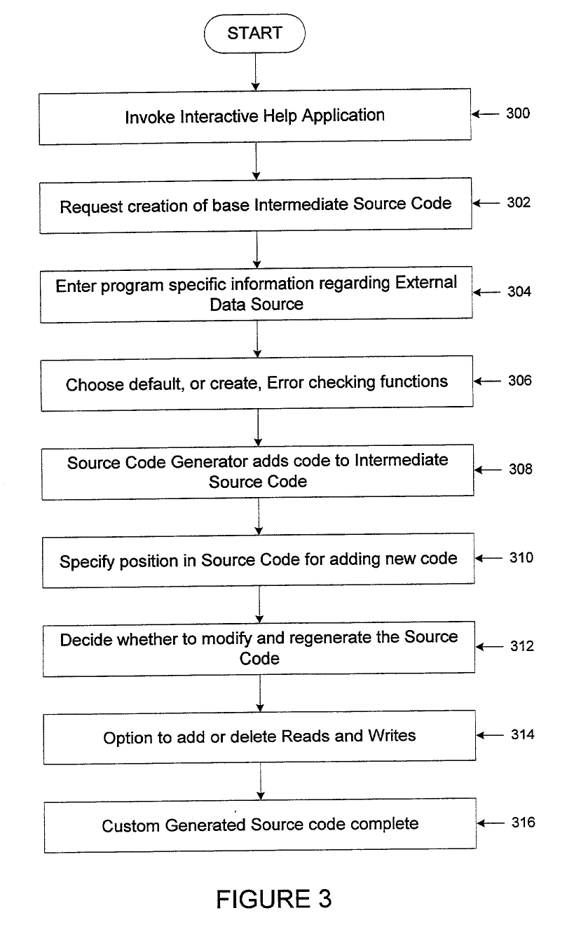

FIG. 3 depicts a method for automatically generating source code in a process control environment according to an advantageous embodiment of the present invention. The tools utilized in the method of the present invention include the previously discussed source code generator 210 (see FIG. 2). To begin construction of an application for providing process control source code, the user invokes interactive help application 200. Interactive help application 200 automatically creates a template input spreadsheet for the project that is being created (in an update mode, interactive help application 200 retrieves the template of the application to be modified) (process step 300). The user then requests source code generator 210 to create a new base source code. Source code generator 210 utilizes template source code 206 to create or modify intermediate source code 208. Intermediate source code 208 contains special markers that identify to source code generator 210 where to add the generated source code 212 for each type of code added (process step 302).

From user input actuator 202, the user enters program specific information regarding external data source 203 to update control software 108 in process control system 100. The user creates lists of items to access. Each item contains the following information: (1) the name of the list in which items are defined; (2) the name of the program variable in the source code that will receive the external data on a Read or supply the value for a Write; (3) the type of data that the external reference identifies (integer, string, etc.); (4) the external reference that identifies the name of the external data item to Read or Write; and (5) whether read, write or read/write code should be generated for this item (process step 304).

The user may then create and assign customized error checking functions to pass any variable identified by the user into the error checking function. Error checking functions may be defined independently from their associated use with a list. A new error checking function may be added, a current error checking function may be modified or deleted. Error checking functions may also be customized to extend the functionality of code inserted by source code generator 210 without modifying the generated code. Alternatively, the user may select and attach a set of default error checking functions that are provided by the present invention. The default error checking functions may also be automatically added without any action by the user. Generated source code 212 contains calls to specific functions to allow the user written source code to examine the return statuses and data and take appropriate action. Generated source code 212 contains external data source 203 behavior, as previously described, entered into database 204 by the user without the user manually interacting with each piece of generated source code (process step 306).

The user then instructs source code generator 210 to add source code to intermediate source code 208 using information from database 204 (from step 302) to define the external data to be accessed. External data is data received from monitors and sensors throughout the process control system. This action adds definition code to identify the program variables that will hold the external values and reference names. To identify locations where code is to be added and where code has previously been added, special comment lines are inserted in the source program. Two types of generated code sections are (1) fixed sections that occur only once per program, and (2) I/O sections that occur each place in the program that a read or write is performed (process step 308).

Interactive help application 200 utilizing information from user input actuator 202 identifies Read or Write locations for source code generator 210 to add code that will perform a Read or Write to the process control system. Source code generator 210 adds the source code based on the definitions contained in database 204. What items to read or write are identified by the list selected by the user. If the list is added to the source code (e.g., a new device is inserted in the system), the source program is searched for specific template sections and constants and variables that are necessary for reading and/or writing current values for each item in the list is added.

In the present invention, each item in database 204 can be selected for Read or Write or Both. Each item with Read or Both flags will be read and each item with Write or Both will be written (refer to the Appendix for sample database entries, generated code, user interface, etc.). For a Read, the program variables identified by the user in process step 302 will contain the external values after the Read. For a Write, the program variables identified by the user in process step 302 will supply the values to Write. The user identified error checking functions (defaults if not selected) will be called for each read value or write value to allow user written specific code to validate the Read/Write action (process step 310).

The user can subsequently modify the information in database 204 and regenerate the source code based on the new definition (the definition code and the Read/Write code will both be updated). The user can add or delete items to the lists of external data to be accessed. Also, the definition of an item can be modified (change data type, external reference, or program variable). Source code generator 210 will find the appropriate code in the program source code, delete the old source code and insert the new source code (process step 312).

Reads or Writes may be subsequently added to or deleted from the generated source code 212. A read I/O call may be inserted, followed by the appropriate get data I/O calls, as the current selection point in the source program. Also, appropriate put data I/O calls, a write I/O call then get data I/O calls for the write status at the current selection point in the source program may be added. Additionally, source code generator 210 can add new Read/Writes into the generated source code 212 or remove any Read/Write already added (process step 314).

The user then exits the source code generator function with the custom generated source code 212 now made available. Source code generator 210 uses intermediate source code 208 (working code) to produce the final generated source code 212. Normally newly-generated source code 212 is then inserted into a program source file within the control software. This newly-generated source code 212 can be further modified to implement the user's specific application functionality. At any time, source code generator 210 can be restarted and used to modify the newly-generated source code 212 as defined in Steps 310 and 312. When re-entering source code generator 210, the current source code is used as the intermediate source code to preserve any modifications to the code done by the user outside the source code generator 210 (process step 316).

The method of the present invention may be summarized as follows: (1) a user requests creation of the base intermediate source code from template source code 206; (2) specific information regarding the external data to access from the process control system is entered into database 204; (3) specific error checking functions are created and assigned for each Read/Write operation step; (4) source code generator 210 adds code to intermediate source code generator 208 using information from database 204 to define the external data to access; (5) Read or Write operations that are to be performed are inserted in appropriate locations by source code generator 210; (6) database 204 can be modified and the source code regenerated based on the new definition (the definition code and the Read/Write code); (7) Reads and Writes can subsequently be added to or deleted from generated source code 212.

The present invention comprises a Windows NT™ tool that automatically generates fully functional Fortran source code. Windows NT™ is a trademark of Microsoft Corporation of Redmond, Wash. The tool, interactive help application 200, comprises a “wizard” and a Dynamic Link Library (DLL) add-in, both seamlessly integrating with the Microsoft Visual Studio™ development environment that, in turn, operates a Fortran compiler. Microsoft Visual Studio™ is a trademark of Microsoft Corporation.

Interactive help application 200 provides a graphical interface that assists and guides a user through each step of adding to or changing both the source code and information in database 204. Users are provided with an easy and efficient way to automatically generate Fortran “Step and Sequence” executables which may be used in a process control system. Interactive help application 200 directs the execution of Windows NT™ based-applications in a process control system.

Once the new source code (a Fortran Step or Sequence) is initially created, and as process I/O data changes, source code generator 210 provides users with the ability to easily and efficiently update and modify all previously generated source code. Software tools of the present invention provide users with the ability to remove any previously generated source code without affecting any user written source code. Source code generator 210 uses an industry standard database (e.g., Microsoft Excel™) containing information in a specific format and an industry standard program development environment (e.g., Microsoft Developer Studio™) for developing source code in concert with the present invention. The present invention seamlessly integrates Microsoft Developer Studio™ for creating a new set of program source code, adding read and/or write data to the program source code and for updating the program source code when the data points change.

Generated source code 212 is a complete program source file that may be added to the process control system source code. After source code generator 210 has added all I/O calls, the user operates the Microsoft Developer Studio™ editor to add any specific control logic. The program source file is then compiled and linked into an executable file within supervisory control 120. This program source file may be subsequently modified with any updates to I/O lists or Reads and Writes.

Although the present invention and its advantages have been described in detail, those skilled in the art should understand that they can make various changes, substitutions and alterations herein without departing from the spirit and scope of the invention in its broadest form.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An apparatus for creating a source code portion for insertion into a program source code, said apparatus comprising:
a database coupled to at least one external data source, said database capable of receiving external data source input data, said input data comprising program variables and data types;
an interactive help application coupled to said database, said interactive help application capable of utilizing the external data source input data to form program source code variables; and
a source code generator coupled to said database and to said interactive help application, said source code generator capable of automatically generating a final version said source code portion and capable of inserting said final version of said source code portion into said program source code.

2. The apparatus for creating a source code portion as set forth in claim 1, further comprising at least one process controller in a process control system coupled to said program source code, said process controller capable of implementing the source code portion in said process control system.

3. The apparatus for creating a source code portion as set forth in claim 1, further comprising:
an intermediate source code application coupled to said interactive help application and to said source code generator, said intermediate source code application capable of updating at least a first version of the source code portion.

4. The apparatus for creating a source code portion as set forth in claim 1, further comprising a template source code application coupled to said source code generator, said template source code application capable of being utilized by said interactive help application to initiate the creation of said source code portion.

5. The apparatus for creating a source code portion as set forth in claim 2, wherein an external data source, responsive to a query by said process control system, transmits external data source input data to said database.

6. The apparatus for creating a source code portion as set forth in claim 1, wherein said external data source input data is manually entered into said database.

7. The apparatus for creating a source code portion as set forth in claim 1, wherein said database is capable of executing manual instructions from a user to add and delete said external data source input in said database; and
wherein said database is capable of executing instructions from said user and said source code generator to modify at least one definition of said external data source stored in said database.

8. A method for creating a source code portion for insertion into a program source code, said method comprising the steps of:
receiving data into a database, said database coupled to at least one external data source, said database capable of receiving external data source input data, said input data comprising program variables and data types of said external data source;
activating an interactive help application coupled to said database to cause said interactive help application to utilize the external data source input data to form program source code variables; and
utilizing a source code generator coupled to said database and to said interactive help application to cause said source code generator to automatically generate a final version of the source code portion and to insert said final version of said source code portion into said program source code.

9. The method for creating a source code portion as set forth in claim 8, further comprising the step of implementing said source code portion in said program source code in at least one process controller in a process control system.

10. The method for creating a source code portion as set forth in claim 8, further comprising the step of maintaining and updating a first version of said source code portion utilizing an intermediate source code application coupled to said interactive help application and to said source code generator.

11. The method for creating a source code portion as set forth in claim 8, further comprising the step of causing said interactive help application to initiate the creation of said source code portion by utilizing a template source code application.

12. The method for creating a source code portion as set forth in claim 9, further comprising the steps of:
querying said external data source;
receiving external data source input data as a result of said query; and
automatically entering said input data into said database.

13. The method for creating a source code portion as set forth in claim 8, further comprising the step of manually entering said external data source input data into said database.

14. A process control system, comprising:
at least one process controller for controlling an external data source, said process controller coupled to a source program in said process control system and comprising:
an apparatus for creating a source code portion for insertion into a program source code, said apparatus comprising:
a database coupled to at least one external data source, said database capable of receiving external data source input data, said input data comprising program variables and data types;
an interactive help application coupled to said database, said interactive help application capable of utilizing the external data source input data to form program source code variables; and
a source code generator coupled to said database and to said interactive help application, said source code generator capable of automatically generating a final version said source code portion and capable of inserting said final version of said source code portion into said program source code.

15. The process control system as set forth in claim 14, further comprising at least one process controller in a process control system coupled to said program source code, said process controller capable of implementing the source code portion in said process control system.

16. The process control system as set forth in claim 14 further comprising an intermediate source code application coupled to said interactive help application and to said source code generator, said intermediate source code application capable of updating at least a first version of the source code portion.

17. The process control system as set forth in claim 14, further comprising a template source code application coupled to said source code generator, said template source code application capable of being utilized by said interactive help application to initiate the creation of said source code portion.

18. The process control system as set forth in claim 15, wherein an external data source, responsive to a query by said process control system, transmits external data source input data to said database.

19. The process control system as set forth in claim 14, wherein said external data source input data is manually entered into said database.

20. The process control system as set forth in claim 14, wherein said database is capable of executing manual instructions from a user to add and delete said external data source input in said database; and
wherein said database is capable of executing instructions form said user and said source code generator o modify at least one definition of said external data source stored in said database.
